(19) United States
(12) Patent Application Publication
(10) Pub. No.: US 2009/0119503 A1
(43) Pub. Date: May 7, 2009

(54) SECURE PROGRAMMABLE HARDWARE COMPONENT

(75) Inventors: Emil A. Isaakian, Cherry Hill, NJ (US); Samuel Nathan Miller, Somerdale, NJ (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: L3 Communications Corporation, New York, NY (US)

(21) Appl. No.: 11/935,781

(22) Filed: Nov. 6, 2007

(51) Int. Cl. H04L 9/38

(52) U.S. Cl. 713/153

(57) ABSTRACT

A cryptographic device may include a programmable hardware component, such as a Field Programmable Gate Array for example, and a processor. The programmable hardware component may encrypt and decrypt data. The programmable hardware component may be securely configured via cryptographically signed and encrypted configuration package. The configuration package may contain a hardware image and executable code. The processor may load the new hardware image onto the programmable hardware device and may execute the executable code to test an operation of the programmable hardware component and the new hardware image. The processor and the programmable hardware component may be physically and/or operationally independent of one another; thus, a security compromise associated with one may not affect the other. Once the programmable hardware component and the hardware image have been tested according to the executable code, the cryptographic device may be ready to encrypt and decrypt user data.

### BACKGROUND

In secure communication systems, a cryptographic device may encrypt and decrypt data. Typically, high performance encryption/decryption circuits may be implemented in dedicated hardware, such as a circuit of individual logic components, an Application Specific Integrated Circuit (ASIC), a Complex Programmable Logic Device (CPLD), and/or a Field Programmable Gate Array (FPGA).

Programmable hardware devices, like the CPLD and the FPGA, may contain logic components and interconnects that may be arranged and rearranged to suit different applications. The logic components may include logic gates (e.g., AND, OR, and XOR); memory elements; and/or embedded micro-processors, for example.

To rearrange the logic components and interconnects, a programmer may describe the logic to be performed in a hardware description language (HDL). The HDL code may be converted to an image file. The image file may define the new arrangement of the logic components and interconnects within the programmable device. The image file may be loaded on the programmable device, thus, implementing the new arrangement of logic components and interconnects within the programmable hardware device.

For example, a secure device, such as a secure telephone, may have an FPGA that encrypts and decrypts data according to an encryption/decryption algorithm. The secure telephone may be manufactured and shipped with a base version of the encryption/decryption algorithm. Later, as new and/or improved encryption/decryption algorithms are developed, new image files may be generated. The new images files may be delivered to and loaded on the programmable device to improve the effectiveness of the secure telephone.

The overall effectiveness of a secure communication system may be enhanced when the delivery and loading of new image files is done securely. If not properly secured, the image file may be maliciously accessed and/or altered. For example, a maliciously accessed image file may release sensitive information about the encryption/decryption algorithm, and a maliciously altered image file may render the secure communications device ineffective.

### SUMMARY

A cryptographic device, as disclosed herein, may include a programmable hardware component and a processor. For example, the programmable hardware component may be a Field Programmable Gate Array. The programmable hardware component may encrypt and decrypt data. The cryptographic device may be securely configured according to a hardware image that corresponds to a cryptographic algorithm. The hardware image may be securely downloaded, authenticated, and tested at the cryptographic device.

The processor may receive a configuration package. The configuration package may contain the hardware image and executable code. Within the configuration package, the hardware image and executable code may be encrypted and cryptographically signed. The processor may verify the signature associated with the configuration package to authenticate the contents of the configuration package. Then, the processor may decrypt the new hardware image and the executable code. To decrypt the hardware image and the executable code, the processor may invoke a key recovery process.

The processor may load the new hardware image onto the programmable hardware device. The processor may execute the executable code to test an operation of the programmable hardware component and the new hardware image. For example, the executable code may direct the programmable hardware component to encrypt test data according to the new hardware image and may direct the processor to compare the encrypted test data to a known control data. A match between the encrypted test data and the known control data may indicate that the programmable hardware component and the new hardware image are operational.

The processor and the programmable hardware component may be physically and/or operationally independent of one another; such that a security compromise associated with the programmable hardware component may not affect the processor. Once the programmable hardware component and the hardware image have been tested according to the executable code, the cryptographic device may be ready to encrypt and decrypt data.

### BRIEF DESCRIPTION OF THE DRAWINGS

FIG. 1 is a block diagram of an example delivery system for updating cryptographic devices.

FIG. 2 is a protocol diagram of an example configuration package.

FIG. 3 is a block diagram of an example configurable cryptographic device.

FIG. 4 is a flow chart of an example process for securely configuring a cryptographic device.

FIG. 5 is a flow chart of an example process for testing a programmable hardware component and a hardware image.

### DETAILED DESCRIPTION OF ILLUSTRATIVE EMBODIMENTS

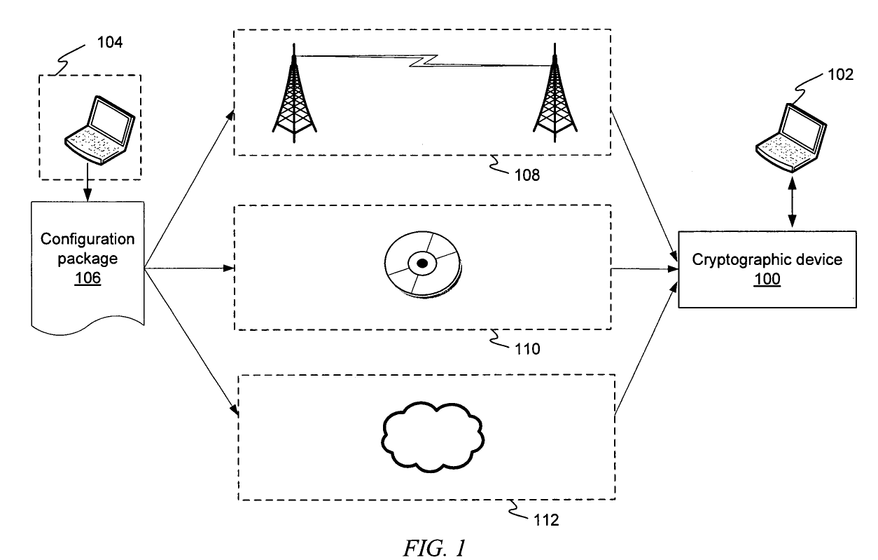

FIG. 1 is a block diagram of an example delivery system for updating cryptographic devices. The delivery system may enable the secure delivery, authentication, and self-testing of a functionality engine for a cryptographic device 100. For example, the cryptographic device 100 may be updated with a new version of a cryptographic algorithm and/or a new algorithm altogether.

The cryptographic device 100 may provide cryptographic functionality for data storage and/or data communications. For example, the cryptographic functionality may include key generation, key exchange, encrypting data, decrypting data, or the like. The cryptographic device 100 may be a Type 1 cryptographic device 100. Type 1 encryption may include any classified or controlled cryptographic algorithm endorsed by the National Security Agency (NSA) for securing classified and sensitive U.S. Government information. The Type 1 designation may refer to products that contain approved National Security Agency (NSA) algorithms. For example, Type 1 algorithms may include FIREFLY, MEDLEY, SAVILLE, WALBURN, or the like. The cryptographic device 100 may provide NSA Type 1 High-Grade/High Assurance while protecting classified information up to the Top Secret/Sensitive Compartmented Information (TS/SCI) level.

The cryptographic device 100 may be used in connection with a communications device 102. The communications device 102 may be suitable for transmitting and receiving data. The communications device 102 may be a computer, handheld device, telephone, or the like. The cryptographic device 100 may be used in connection with the communications device 102 to provide secure communications via the communications device 102. For example, a user may have a laptop computer. The cryptographic device 100 may enable cryptographic functionality for communications to and from that laptop computer. Also for example, the cryptographic device 100 may provide cryptographic functionality to a telephone. The cryptographic device 100 may provide the encryption and decryption of the voice-band data associated with that telephone.

From time to time, the functionality of the cryptographic device 100 may be changed. For example, updated cryptographic algorithms may be developed. The functionality of the cryptographic device 100 may be changed to conform with the updated cryptographic algorithms. For example, cryptographic algorithms may be updated to improve security, patch vulnerabilities, improve efficiency, or the like.

In the example delivery system, the updated cryptographic algorithms may be developed remote from the cryptographic device 100. For example, the updated cryptographic algorithms may be developed in a secure facility 104. The updated cryptographic algorithms may be formatted into a configuration package 106. The configuration package 106 may be transported to the cryptographic device 100.

While being transported, the configuration package 106 may be in an unsecured environment. For example, the configuration package 106 may be transmitted through a wireless communications channel 108, a physical communications medium 110 and/or physical storage medium, and/or a wireline network 112. For example, the configuration package 106 may be sent via microwave and/or satellite link, CD-ROM, DVD-ROM, flash memory, the Internet, an intranet, e-mail, file transfer protocol (FTP), World Wide Web (WWW) download or the like. The configuration package 106 may maintain the confidentiality and/or the data integrity of the algorithms. For example, parts of the configuration package 106 may be encrypted and/or digitally signed. The configuration package 106 may include a self-test. The self test may determine that the cryptographic device 100 loaded with the updated cryptographic algorithms from the configuration package 106 is operational and that the cryptographic algorithms have not been compromised during their communication to the cryptographic device 100.

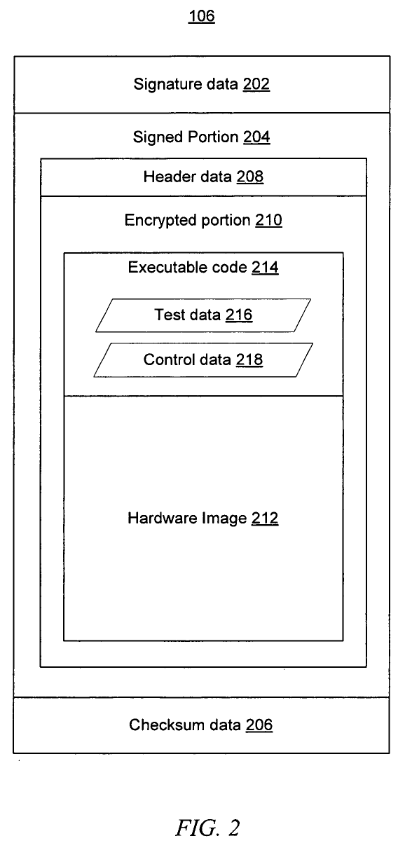

FIG. 2 is a protocol diagram of an example configuration package 106. The configuration package 106 may include signature data 202, a signed portion 204, and/or checksum data 206.

The signature data 202 may include data that may prove the source of the signed portion 204. For example, the signed portion 204 may be cryptographically signed, resulting in a digital signature. The signature data 202 may include the digital signature associated with the signed portion 204. The signed portion 204 may be hashed using a hashing algorithm, such as SHA-1, for example, resulting in a hash digest. The resultant hash digest may be encrypted via a public/private key encryption algorithm, such as RSA, for example. The public/private key encryption algorithm may define a public key and an associated private key. The hash digest may be encrypted with the private key resulting in an encrypted hash digest. The signature data 202 may include the resultant encrypted hash digest. The signature data 202 may specify the hashing algorithm. The signature data 202 may include a digital certificate for a public key infrastructure (PKI) authentication process.

The validity of the source of a received signed portion 204 and signature data 202 may be determined. The encrypted hash digest of the signature data 202 may be decrypted using the public key. The signed portion 204 may be hashed using the same hashing algorithm used to create the signature data 202. The resultant hashed data may be compared with the hash data of the signature data 202. If the two hashes match, then the signed portion 204 is authenticated to have been digitally signed by the corresponding private key. If the two hashes differ, then the received signed portion is not authenticated. The received signed portion may have been altered since the time at which the signature data 202 was generated.

The signed portion 204 may include header data 208 and an encrypted portion 210. The header data 208 may include information identifying the substance of the encrypted portion 210. The header data 208 may include a serial code to specify a revision and an associated cryptographic device 100. The header data 208 may indicate the model and/or type of cryptographic device for which the configuration package 106 is intended.

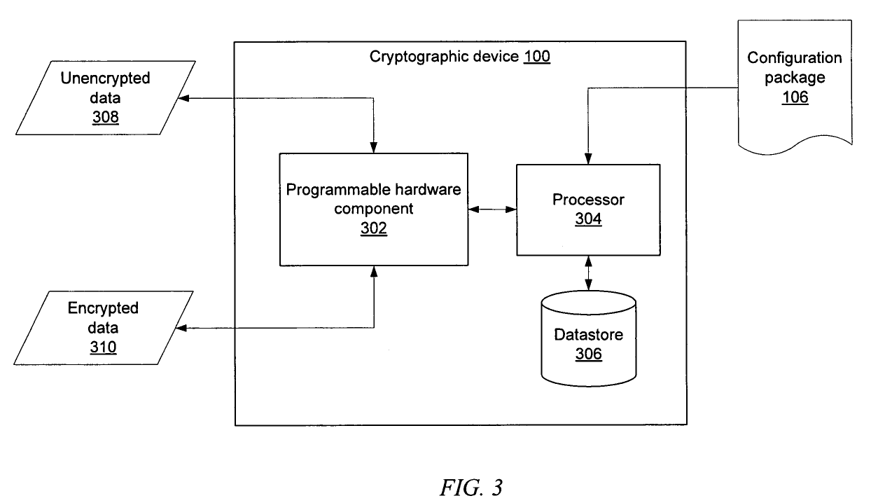

The encrypted portion 210 may include a hardware image 212 and/or executable code 214. The hardware image 212 may include data indicative of the operation of a programmable hardware component 302 (see FIG. 3), such as a Field Programmable Gate Array (FPGA), for example. The hardware image 212 may include data indicative of logic-cells, interconnects, carry chains, and internal Random Access Memory (RAM) operations associated with the FPGA. The hardware image 212 may define the operation of the FPGA. For example, the hardware image 212 when loaded on an FPGA may enable a cryptographic function, such as the encryption and/or decryption of data.

The hardware image 212 may be associated with source code. The source code may be programmed according to a programming language such as C++, hardware description language (HDL), or the like. The source code may define the operation of the programmable hardware component 302 in connection with the cryptographic device 100. The source code may be converted to a hardware image 212 suitable for being loaded onto the programmable hardware component 302.

The executable code 214 may include data suitable for instructing a processor 304 (see FIG. 3). For example, the executable code 214 may include machine code. The machine code may implement a self-test program. The self-test program may test an operation of a programmable hardware component 302 in combination with the hardware image portion 212.

The executable code 214 may include test data 216 and/or control data 218. The self-test program may cryptographically-alter the test data 216 and compare the cryptographically-altered test data 216 with the control data 218. For example, the self-test program may direct the programmable hardware component 302 to encrypt the test data 216. The self-test program may compare the resultant encrypted test data with the control data 218. A match between the encrypted test data and the control data 218 may indicate a properly operational hardware image portion 212. A non-match between the encrypted test data and the control data 218 may indicate a compromised and/or inoperable hardware image portion 212.

The configuration package 106 may include checksum data 206. The checksum data 206 may include any data that enables a redundancy check of the configuration package 106. The checksum data 206 may protect the integrity of the configuration package 106 by detecting errors. The checksum data 206 may include a Fletcher's checksum, an Adler-32 checksum, a cyclic redundancy check (CRC), or the like.

FIG. 3 is a block diagram of an example configurable cryptographic device 100. The cryptographic device 100 may include a programmable hardware component 302, a processor 304, and/or a datastore 306. The processor 304 may be in communication with the programmable hardware component 302 and/or the datastore 306. The cryptographic device 100 may encrypt/decrypt data for storage and/or communications. The cryptographic device 100, via the programmable hardware component 302, may convert unencrypted data 308 into encrypted data 310. The cryptographic device 100, via the programmable hardware component 302, may convert encrypted data 310 into unencrypted data 308.

The programmable hardware component 302 may be any hardware component that is updatable and/or programmable. The programmable hardware component 302 may include a collection of logic gates with programmable interconnections. For example, the programmable hardware component 302 may include a Complex Programmable Logic Device (CPLD) and/or a Field Programmable Gate Array (FPGA).

The programmable hardware component 302 may operate according to a hardware image. The hardware image may define the interconnections between and/or among the logic gates of the programmable hardware component 302. The hardware image may be loaded onto the hardware programmable component. The hardware image 212 may be included in the configuration package 106.

The programmable hardware component 302 may include a plurality of logic-cells. For example, an FPGA may include thousands of logic-cells. Each logic-cell may include a lookup table, a flipflop, and/or a 2-to-1 multiplexer. Each logic-cell may define a logical operation, such as an OR logic gate, an AND logic gate, a XOR logic gate, or the like. The FPGA may include internal RAM. The logic-cells may be interconnected via interconnects such as conductive paths, carry chains, and/or multiplexers. The FPGA may include input/output (I/O) resources that enable the FPGA to receive and send data.

The interconnection of logic-cells may define complex logic operations, such as those that may implement cryptographic algorithms. The FPGA may perform the complex logic operations on data received from the I/O resources. The FPGA may provide the results of the complex logic operations in data sent from the I/O resources.

The datastore 306 may be in communication with the processor 304 and/or the programmable hardware component 302. The datastore 306 may be any component, system, and/or subsystem suitable for storing data. The datastore 306 may be RAM, register memory, buffer memory, magnetic disk memory, flash memory, or the like. The datastore 306 may have stored thereon computer executable instructions that direct the operation of the processor 304. The datastore 306 may have stored thereon data received from the processor 304, such as generated encryption keys, for example.

The processor 304 may include any system, subsystem, or component for digital computing. For example, the processor 304 may include a microprocessor, a Digital Signal processor 304 (DSP), or the like. For example, the processor 304 may be an Advanced RISC Machine (ARM) processor 304. The processor 304 may operate a Real-Time Operating System (RTOS).

The processor 304 may be a hardware component independent from the programmable hardware component 302. For example, the processor 304 may direct the operation of the cryptographic device 100. The processor 304 may enable and/or disable operation of the programmable hardware component 302. The programmable hardware component 302 may be controlled by the processor 304. The processor 304 and the programmable hardware component 302 may mount separately to a circuit board. The processor 304 may communicate with the programmable hardware component 302 via conductive traces on and/or within the circuit board that connects the processor 304 and the programmable hardware component 302.

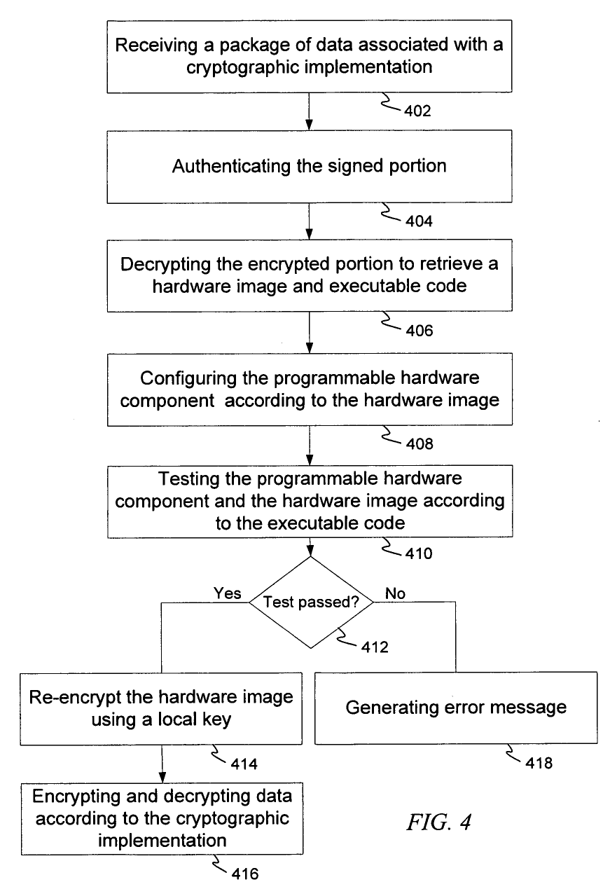

FIG. 4 is a flow chart of an example process for securely configuring a cryptographic device 100. The processor 304 may receive the configuration package 106, authenticate the configuration package 106, decrypt the encrypted portion 210 of the configuration package 106, program the programmable hardware component 302 according to the hardware image 212, and execute the executable code 214 to test an operation of the now programmed programmable hardware component 302.

At 402, the processor 304 may receive the configuration package 106. The configuration package 106 may be associated with a cryptographic implementation. For example, the hardware image 212 of the configuration package 106 may define an implementation of a cryptographic algorithm and/or operation. The processor 304 may receive the configuration package 106 via a communications port (not shown) of the cryptographic device 100. The processor 304 may store the configuration package 106 at the datastore 306. The processor 304 may perform an integrity check of the configuration package 106 in accordance with the checksum data 206.

At 404, the processor 304 may authenticate the signed portion 204 of the configuration package 106. The processor 304 may decrypt the signature data 202 with the public key associated with the intended source of the configuration package 106. The public key may be retrieved from the datastore 306. For example, the datastore 306 may have been loaded with the public key when the cryptographic device 100 was deployed. The public key may be received via an external server. For example, the cryptographic device 100 may communicate a PKI session to retrieve an appropriate public key. The processor 304 may hash the signed portion 204 of the cryptographic package and compare the resultant hashed signed portion 204 with the decrypted signature data 202. A match may indicate that the configuration package 106 is authenticated. A non-match may cause the processor 304 to trigger an error and/or exception procedure.

At 406, the processor 304 may decrypt the encrypted portion 210 of the configuration package 106 with a first cryptographic key. The processor 304 may determine the first cryptographic key. For example, the processor 304 may retrieve the first cryptographic key from the datastore 306. For example, the processor 304 may determine the first cryptographic key by using a series of cryptographic one way functions based upon a shared secret and random salt value. For example, a secret random component may be combined with a public random value that was contained in the configuration package. This combined value may be the input into the series of one way functions to produce the first cryptographic key. This first cryptographic key may then be used to decrypt the encrypted portion of the configuration package. The decryption process relying on the first cryptographic key may be a symmetric or asymmetric algorithm process.

Once the encrypted portion 210 of the configuration package 106 is decrypted, the processor 304 may extract the hardware image 212 and/or the executable code 214. The processor 304 may store the hardware image 212 and/or the executable code 214 at the datastore 306.

At 408, the processor 304 may configure the programmable hardware component 302 according to the hardware image 212. The processor 304 may load the hardware image 212 onto the programmable hardware component 302. The processor 304 may program the programmable hardware component 302 according to the hardware image 212. For example, the processor 304 may place the programmable hardware component 302 into a configuration mode and may communicate the hardware image 212 to the programmable hardware component 302. The processor 304 may then place the programmable hardware component into an operational mode, such that the programmable hardware component 302 operates in accordance with the hardware image 212.

At 410, the processor 304 may test the operation of the programmable hardware component 302 in connection with the hardware image 212. For example, the processor 304 may test that the programmable hardware component 302 operates according to the newly received hardware image 212. The processor 304 may perform a series of tests. The series of tests may include an in-circuit scan test to verify the integrity of the logic elements within the hardware component. This test may be designed to insert single bit faults into each location in the hardware component to verify that the internal protection circuits are able to detect the failure.

The processor 304 may execute the executable code 214 from the configuration package 106. The executable code 214 may include a test of an operation of the programmable hardware component 302 as programmed according to the hardware image 212 from the configuration package 106. The test may be designed to specifically address a feature of the hardware image 212.

The processor 304 may test the operation of the programmable hardware component 302 independently of the operation of the programmable hardware component 302 itself. For example, the processor 304 may be hardware separately operable from the programmable hardware component 302, such that the processor 304 may be protected from a compromise of an operation of programmable hardware component 302. To illustrate, the configuration package 106 may be compromised in a way that effects the operation of the programmable hardware component 302. The processor 304 may be operationally independent of the programmable hardware component 302, such that the compromise does not affect the operation of the processor 304 including the tests. The compromise of the programmable hardware component 302 may not affect the processor's test of the programmable hardware component 302. The test may be isolated from the compromise code via the independence of the processor 304. The test may be protected from effects of the compromise, and the test may detect the compromise.

At 412, the result of the test may be determined. A successful test (i.e., the test was passed) may indicate that the programmable hardware component 302 in connection with the hardware image 212 may be properly operational. An unsuccessful test (i.e., the test was failed) may indicate a problem with the programmable hardware component 302 and/or the hardware image 212. For example, the hardware image 212 may have been compromised and/or altered.

At 414, where the test was passed, the processor 304 may re-encrypt the hardware image 212 using a locally generated key. The processor 304 may store the re-encrypted hardware image 212 at the datastore 306. The processor 304 may generate a second cryptographic key. The processor 304 may encrypt the hardware image 212 with the second cryptographic key and store the second cryptographic key and/or the newly encrypted hardware image 212 at the datastore 306. Using the locally generated second cryptographic key may provide improved protection of the hardware image 212 while it is stored in the cryptographic device 100. This re-encryption of the hardware image 212 may use a local storage algorithm that allows for faster decryption of the hardware image 212 following restarts of the cryptographic device 100. When the cryptographic device 100 is power cycled, the processor 304 may retrieve the re-encrypted hardware image 212 from the datastore 306 and load the programmable hardware component 302.

At 416, the cryptographic device 100 may begin operation. The operation may include encrypting and decrypting data according to the cryptographic algorithm defined by the hardware image 212. The operation may include other cryptographic functions such as hashing data, key generation, or the like.

At 418, where the test was failed, the cryptographic device 100 may generate an error message. The cryptographic device 100 may initiate an exception procedure that may include disabling operation of the cryptographic device 100. For example, the exception procedure may delete stored key data.

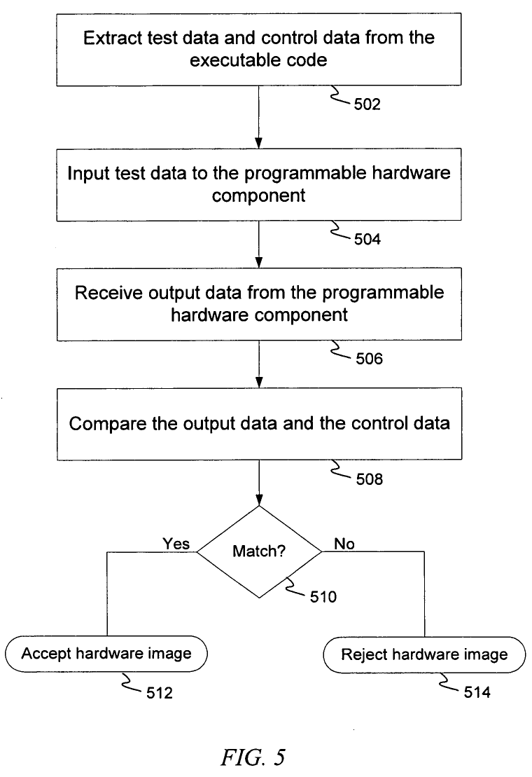

FIG. 5 is a flow chart of an example process for testing a programmable hardware component 302 and a hardware image 212. The testing shown in FIG. 5 may correspond with the testing indicated at 410 of FIG. 4. The processor 304 may execute the executable code 214 from the configuration package 106. The executable code 214 may include a test of the operation of the programmable hardware component 302 as programmed according to the hardware image 212 from the configuration package 106.

At 502, the processor 304 may extract the test data 216 and the control data 218 from the configuration package 106. For example, the processor 304 may extract the test data 216 and the control data 218 from the executable code 214.

At 504, the processor 304 may input the test data 216 to the programmable hardware component 302. For example, the executable code 214 may direct the processor 304 to communicate a command and/or the test data 216 to the programmable hardware component 302.

The programmable hardware component 302 may operate on the inputted test data 216 according to processing defined by the hardware image 212. For example, the hardware image 212 may define an updated cryptographic algorithm, and the programmable hardware component 302 may apply the updated cryptographic algorithm to the inputted test data 216. The updated cryptographic algorithm may include encryption, decryption, hashing functions, key generation, or the like.

In response to the input and/or the command, the programmable hardware component 302 may return a result. At 506, the processor 304 may receive output data from the programmable hardware component 302. The output data may correspond to the input data and the processing defined by the hardware image 212. For example, the output data may be an encrypted version of the inputted data. For example, the output data may be a decrypted version of the inputted data.

At 508, the output data may be compared with the control data 218 from the configuration package 106. The control data 218 may include a previously determined result that properly matches the processing defined by the hardware image 212. The control data 218 may have been determined to properly correspond to the operation of the programmable hardware component 302 in connection with an authorized hardware image 212, such that the programmable hardware component 302 in connection with an unauthorized and/or compromised hardware image 212 may return a result that differs from the control data 218.

At 510, the processor 304 may determine if the output data and the control data 218 match. A match may indicate that the programmable hardware component 302, as programmed according to the hardware image 212, is operational. A non-match may indicate that the hardware image 212 is non-operational. The processor 304 may indicate that the programmable hardware component 302 and the hardware image 212 passed or failed the test defined by the executable code 214.

At 512, where the output data and the control data 218 match, the processor 304 may accept the hardware image 212. The processor 304 may indicate that the test was passed. The test may ensure proper operation of the FPGA functionality after programming the device. By executing the test of the programmable hardware component 302 in the physically independent processor 304, the test may ensure that a compromised hardware image 212 may not be allowed to compromise the cryptographic system by alluding detection.

At 514, where the output data and the control data 218 do not match, the processor 304 may reject the hardware image 212. The processor 304 may trigger an error and/or an exception procedure in response to the non-match.

What is claimed:

1. A device comprising:
a programmable hardware component; and
a processor in communication with the programmable hardware component, wherein the processor is adapted to receive a package of data comprising an executable portion and a hardware image portion, to load the hardware image portion onto the programmable hardware component, and to run the executable portion to test an operation of the programmable hardware component in combination with the hardware image portion.

2. The device of claim 1, wherein the programmable hardware component is a Field Programmable Gate Array (FPGA).

3. The device of claim 1, wherein the operation of the programmable hardware component in combination with the hardware image portion comprises cryptographic processing.

4. The device of claim 3, wherein the executable portion comprises machine code that, when executed, tests the cryptographic processing.

5. The device of claim 1, wherein the executable portion and the hardware image portion are encrypted within the package, and wherein the processor decrypts the executable portion and the hardware image portion.

6. The device of claim 1, wherein the package comprises a cryptographic digital signature, and wherein the processor is adapted to authenticate the executable portion and the hardware image portion according to the digital signature.

7. The device of claim 1, wherein the package comprises test data and control data, and wherein the processor is adapted to input to the programmable hardware component the test data, to receive cryptographically-altered test data from the programmable hardware component, and to compare the cryptographically-altered test data with the control data.

8. The device of claim 1, wherein the processor is adapted to disable the operation of the programmable hardware device according to a result of the executable portion when run.

9. The device of claim 1, wherein the processor and the programmable hardware component are independently controlled.

10. A method for configuring a programmable hardware component, the method comprising:
receiving a package of data comprising an executable portion and a hardware image portion;
loading the hardware image portion onto the programmable hardware component; and
running the executable portion to test an operation of the programmable hardware component in combination with the hardware image portion.

11. The method of claim 10, wherein the programmable hardware component is a Field Programmable Gate Array (FPGA).

12. The method of claim 10, further comprising authenticating the executable portion and the hardware image portion according to a digital signature, wherein the package comprises the digital signature.

13. The method of claim 10, further comprising decrypting the executable portion and the hardware image portion.

14. The method of claim 10, wherein running the executable portion comprises testing a cryptographic function of the programmable hardware component.

15. The method of claim 10, further comprising inputting to the programmable hardware component test data, receiving cryptographically-altered test data from the programmable hardware component, and comparing the cryptographically-altered test data with control data, wherein the package comprises the test data and the control data.

16. The method of claim 10, further comprising disabling the operation of the programmable hardware device according to a result of the executable portion when run.

17. A system for configuring a programmable hardware component, comprising:
a datastore having stored thereon an executable portion and a hardware image portion; wherein the executable portion comprises first instructions that when executed tests an operation of the hardware image portion in connection with the programmable hardware component; and
a device to load the hardware image portion from the computer readable medium onto the programmable hardware component and to run the executable portion.

18. The system of claim 17, wherein the executable portion and the hardware image portion are encrypted.

19. The system of claim 17, wherein the executable portion and the hardware image are cryptographically signed according to a digital signature, and wherein the datastore has stored thereon the digital signature.

20. The system of claim 17, wherein the first instructions when executed generate a result, and wherein the executable portion comprises second instructions that when executed disables the operation of the hardware image portion according to the result.
